(19) United States
(12) Patent Application Publication
(10) Pub. No.: US 2019/0104697 A1
(43) Pub. Date: Apr. 11, 2019

(54) MODULAR ELECTRONIC VASE WITH AUTOMATED, DIGITAL CONTROL AND MONITORING SYSTEM, USED FOR AEROPONIC GROWTH OF PLANTS IN INNER AND OUTER ENVIRONMENTS

(71) Applicant: Roberto Silva MENDES, Nova Lima (BR)

(72) Inventor: Roberto Silva MENDES, Nova Lima (BR)

(21) Appl. No.: 16/087,878

(22) PCT Filed: Feb. 3, 2017
(86) PCT No.: PCT/BR2017/050023

§ 371 Date: Sep. 24, 2018

(30) Foreign Application Priority Data
Mar. 30, 2016 (BR) PCT/BR2016/007035

(51) Int. Cl. A01G 31/02

(52) U.S. Cl. CPC A01G 31/02; A01G 2031/006

(57) ABSTRACT

The invention relates to a device for growing plants with aeroponics, in the form of a dismountable modular vase composed of superposed modules (4) linked by joining rings (2) and covered by a sealing lid (1) or (21). The modules have a plurality of mouthpieces (5) symmetrically distributed at angular positions, into which the accessories are introduced, such as the rooting basket (6), the micro-greenhouse (22), the seed capsule in the form of a foam cube for germination (23), the support disks (24), (26) or (27), the rod (28) and the grid (29). A tank in two parts (32) and (33) forms a base for the device and comprises an inspection and supply lid (7), a protective grid (8) an on/off switch (9), a connection (10) for the power cable, rollers (30), support legs (31) and an electronic panel (11) that displays information about the level of the nutrient solution, temperature, humidity, timer control and automatic actuation functions of the electric components and electronic circuits. The device actuating components are housed inside, together with the float (15) which stores a mini-generator (16) of nutrient solution nanoparticles, a ventilation pump (17) with an air hose (18), a silencing capsule (19) and a ruler (20) with level sensors.

The present invention is directed to an electronic device in a form of a dismountable vase, intended for the cultivation of multiple species of plants (leafy vegetables, flowers, herbs, fruits, vegetables, seedlings, cutting, etc.), using a method of cultivation in which the roots hang suspended in the air—hydroponic and aeroponic—without the use of soil (dirt). It is intended for residential and commercial use and for educational and social purposes in rural or urban areas, both indoors and outdoors. It operates in a low voltage electric system or it can be connected to external batteries or photovoltaic energy plates, if applicable, when electric power is not available. It offers the possibility of growing plants, from germinating a seed until harvest in only one step. The “standard” model can hold 40 plants. As more growing modules are added, it is possible to reduce or increase the capacity of cultivation; the recommendation is to plant up to 80 plants per system. All components and combined accessories form a unique set of plant growing, self-manageable system, that includes: lighting for photosynthesis, growing modules integrated with several sockets that are distributed at angular positions, micro-greenhouse, support tray, rods and supporting disks for plant suspension, rooting basket, reservoir with an electronic panel with digital display, Wi-Fi, programmable timer, that is capable of setting time and controlling the air flow and oxygenation of the nutrient solution, ventilation system, temperature control; moisture, Ph, TDS/EC levels, Wi-Fi, UV-C light, heating, cooling, antifungal system and water level tracking system in real-time by monitoring of the built-in sensors on the digital display; the mini-generator, which is installed on a floating buoy and is partially submerged in a rich solution of organic nutrients and/or minerals and generates an automatic irrigation into the growing modules, by creating, in a few seconds, a mist of particles, formed by micro and nanoparticles of the nutrient rich solution, which are applied directly to the plant roots, suspended in the air inside the dark air chamber, which is formed by the junction of all growing modules and the reservoir, where the nutrient rich solution (regular water, vitamins and nutrients) stays at the bottom and all electronic and electrical parts stays at the top. This system doesn't require a vacuum pump (pneumatic or hydraulic) nor need manual irrigation, constant water replenishment or hydraulic connections. Suitable for standing on floors and flat surfaces, it makes plant cultivation simpler and faster, saving water, energy and space. It comes in different colors and it has a functional design. The invention is easily controlled via application or web platform by accessing any smartphone, smartwatch, tablet or equivalent product.

Currently, most of the agriculture cultivation is done by the traditional method of planting, which mainly uses soil. It is very common to plant vegetable and flowers in pots, vases, boxes, blocks, ecological-friendly bags, roofs, horizontal beds, vertical walls, screens, decorative cut-out blocks (cobogos), PVC pipes and even plastic bottles at home, in a more rustic way, especially in the cities. The low productivity of home-grown plant cultivation is barely enough to cover the needs of a family and still requires attention, large distance between plants, good spacing, a sunny area, plant rotation, constant cleaning and maintenance (practically daily for some types of plants), and the amount of time necessary for flower or vegetable gardening is discouraging for many people, despite the crescent desire of today's society, especially in urban centers, to organically grow their own food, spices, herbs or flowers. In small, medium or large rural areas, crop production requires a high consumption of water, uses of a lot of pesticides (which is either lost in the soil or is taken away by rain contaminating rivers, etc.), demand a large labor force and constant physical effort of the farmer, and the end product costs relatively high due to considerable losses. In addition to costing more for transportation, products are subject to contamination on the road, great waste and most of the agricultural production sites are far from the cities. Crops have low added value and the farmer is subject to plenty of difficulties related to pests, fires, changes in climate, and water and soil quality, which varies according to each region on the globe. These difficulties cause other indirect problems like financial difficulties for family agriculture, migration of people from rural areas the city; food shortage; deforestation; environmental damage to flora and fauna, genetically modified foods with lower vitamin and nutrient intakes that, despite having looking the same and aspect and size to attract consumers, scientific studies have led to believe that some of these genetically modified foods may be linked to diseases and nutritional imbalances for many people. The situation worsens for those who consumes a high intake of industrialized foods.

On a lesser extent, the cultivation of plants using the hydroponic cultivation method is also performed and it is considered a modern technique in agriculture. Hydroponics is a type of plant cultivation system used inside greenhouses and without the use of soil. Water and other substrates are used to moisten and nurture plants. These systems, on the other hand, are more targeted to rural producers, since it requires a better understanding of the technique, and a more precise control in the mixture of NPK nutrients (nitrogen, phosphorus and potassium) also called macronutrients for the composition of fertilizers that are diluted in the water that continuously irrigate the area. It requires structures with significant investment (greenhouses, culture beds, shade cloths, etc.), demand a high consumption of electrical energy and not necessarily mean that fertilizers are not being used. On the contrary, in many cases the use of fertilizers is superior to the traditional planting method or it diverges from organic cultivation, which ends up increasing the prices of food, and causing low productivity and a shortage of options, bringing foods to the markets that do not have guarantee of safety and origin. In most of the cases, with some exceptions, the product doesn't have any type of official certification like: organic. This leads to many uncertainties for the consumers who are not growing their own food. The other commercially known techniques are either not significant or not very well disseminated between producers and consumers who are more conscious and more demanding than ever. Today's society is looking for alternatives to increase food production in the world, reduce the use of agrochemicals, pesticides, hormones and poisonous substances, and especially to conserve water, primarily in areas closer to urban centers. Most of the useable water in the world is used in irrigation systems.—“The United Nations (UN) reveals that approximately 70% of all the water resources in the world is used for agricultural irrigation” In Brazil, this index is 72%. Irrigation is an essential sector for the world's food supply, and the most wasteful input of a very important resource for life: water. From the analysis of the latest reports released by the UN, water consumption has been increasing at a rate twice as higher than the rate of population growth over the past century. By this rate, water consumption will increase by up to 50% by 2025 in developing countries; and 18% in developed countries. Nowadays, 780 million people still live without access to drinking water and many live without basic sanitation. For this reason, discussion about water safety must be taken seriously to ensure that in the future water is available for food production, power generation, transportation and preservation of vital ecosystems. The World Water Day is celebrated on March 22, and every year, on this date, the UN releases warnings regarding food production and the preservation of natural resources. Another fact about water waste emphasizes the need for water saving. By 2025, it is expected that about 2 million people will live in regions with absolute scarcity of water. Agriculture is seen by international organizations as a priority target for water control policies. According to the Food and Agriculture Organization of the United Nations (FAO), about 60% of the water used in irrigation projects is wasted by phenomena like evaporation. According to the Organization, a reduction in 10% on water waste would be enough to supply a number of people twice the amount of today's world's population. The Brazilian National Water Department—Agência Nacional de Águas (ANA)—reports that Brazil 29.6 ha are estimated to be suitable for irrigation. A lighter, healthier and nutritious diet is linked directly to better overall health. Every day we see initiatives searching for more sustainable and ecological solutions, beyond agriculture, and even in unthinkable sectors like: architecture, design, industry, engineering, consumer products manufacturing, etc.

Finally, we have the aeroponics cultivation method, a technique considered relatively new that derives from hydroponics and, like the hydroponic method, does not require the use of soil. In aeroponics, the use of many substrates is not needed, and the technique prioritizes space optimization (an important point) while achieving a higher productivity. The cultivation process is done with the plant suspended in the air—aeroponics, fixed by the stem or inside of a basket. With billions of people in the world, evidently, there were countless attempts to develop projects and products, but none of they brought any viable results yet, commercially or even aesthetically, that could make possible for the common citizen, especially Brazilians, Asians, Latinos or from any underdeveloped country, to plant their own vegetable garden at home, in a limited space, and that is sufficient to supply the main need of a whole family or a community with healthy and trustworthy foods. In developed countries there are more incentives, consciousness, and appreciation for healthier habits and a more sustainable lifestyle. There are many other methods, research and ideas of plant cultivation systems that attempt to use this technique or equivalent, some of them even add aquariums with fish (aquaponics) or floating structures that move beneath the sea, but they still have flaws and their cost makes them impracticable. However, all of them, commonly, use a continuous supply of energy and a container that may be in different shapes and sizes filled with water and nutrients. This container could be a box, a basin, a jug, a tank, a barrel, a well, a bowl, a bucket coupled to hoses, PVC piping connected to water pumps (normally of the same type used in aquariums) that conducts water to the plants by dripping it into the chambers or using sprays generated by electric pumps (low or high pressure). In some cases, it is possible to use, optionally, one or more sprays, grids or devices that deliver moisture into the roots in the form of a mist, (the same type used in inhalers, decorative water fountains, fog machines, humidifiers and other equivalent devices). In general, they are unfinished, use fragile components in their structure, need extra protection, are not resistant enough for outdoor environments, are not user-friendly, can't hold a lot of plants, some require big spaces, they are manufactured with simple materials found in the market like PVC pipes, plastic containers used as organizers or buckets, their use is restricted and specific to only some types of plants and planting method, and they depend on specific substrata and certain planting abilities in many stages of the cultivation process until harvest. In many countries, they are also used, incorrectly and unlawfully, for the illegal cultivation of Cannabis. They utilize a complex exhaust systems, classic refrigerators, cabins or tents. They come in a variety of shapes and models: vertical, trapezoidal, horizontal, structures for walls etc., but they are not financially or technically feasible to many people nor have the capacity to many different functions. It is not possible to effectively optimize its cost-benefit and they are aesthetically appealing. They are complex to operate, and handling is difficult, they have their sprinklers constantly clogging and oxidizing, suffer with fungi and bacteria proliferation, and they do not offer a set of basic accessories for proper maintenance and planting. In many cases, they are inefficient and not practical for everyday use, very few models are Wi-Fi enabled, which is a key item in modern life, and most of them do not offer online digital monitoring and force the consumer to acquire other software or hardware, devices, feeders, electric cables, miracle structures of various shapes and sizes and other parts that are necessary for planting and that are not cost efficient as many may be acquired separately adding to the cost of the planter, creating not only a financial loss but a feeling of frustration to the less experienced or unaware consumer.

Being aware of the issues mentioned before, and by recognizing the best of each method of plant cultivation and knowing about a more advanced technique of plant cultivation management associated with the results of a study combined with the use of the latest technology available, we aim to solve such inconveniences and we propose an accessible solution that is capable of meeting the needs of a larger number of people in both urban and rural areas with the ability to supply the food consumption of a household with maximum productivity in a more natural, safe, continuous and simplified way, and also saving water, energy and space. By developing this invention, we want to provide the possibility of cultivating multiple plants, which the most relatively significant are: lettuce, arugula, tomatoes, strawberries, beets, sweet peppers, chives, watercress. cauliflower, broccoli, rosemary, parsley, spinach, hot peppers, violets, squash, potatoes, tree seedlings, fine herbs, medicinal herbs, aromatic herbs and endless variety of plants at the same time and in the same structure. The structure in accordance with this invention is composed of growing modules that are interconnected and can be expandable according to the number of plants that can be grown in a limited space, as its structure is smaller than 60 cm at the base, therefore 10× smaller than the commercially known system, and its height is extendable, ranging from 1.10 m (2 growing modules) to 2.20 m (4 growing modules). Each module has the capability to grow 20 different plants on average. The present invention can save approximately 99% of water usage in comparison to the traditional method, with zero waste, because it uses nutrient rich nanoparticles inside of a closed chamber, can use tap water from any sink or other sources of water reuse, such as rain, eliminating by 100% the need to use soil (dirt), saving 95% of energy, when compared to the hydroponics cultivation method. The growth rate of the plant can be up to 46% faster, depending on the species planted due to a more precise and much cleaner system of control and monitoring. It promotes a 90% reduction of physical effort, because its ergonomic structure requires very little maintenance from the user. It is completely free of pesticide, and even so reduces pest attacks by up to 85% on organic salad greens cultivation by enabling to plant natural insect repellents in the same structure. This invention has a low cost of acquisition while using the best technology available, making it accessible to both city people or country farmers. This model simplifies the process of planting, from seed germination to harvest, and it does not require plan transfers or other form of replanting. It combines all steps into one, eliminating the need of ambience exchanges and nursing, the use of greenhouses, and may also eliminate the need for natural sunlight, as it includes an artificial lighting system that enables plant growth in indoors environments with lack of ventilation or sunlight. The main structure is composed of recycled hard plastic and its design is unique and contemporary. It is available in several versions and structure combinations that can be adapted to any environment (indoors or outdoors) or location (urban or rural). Unlike everything that has been seen by most people, it surprises experts and fascinates the most modest people, promotes a feeling of wellbeing, inspires gastronomy and captivates nature lovers and enthusiasts of a healthy life style. The research, science and technology applied to this invention were compiled into a user-friendly model that is simple to operate, easy to assembly and requires low maintenance. Its basic components are inexpensive, simple to put together and aesthetically beautiful (trendy) that can be adaptable to any décor or landscaping project, while holding such advanced technology.

This invention is light, detachable, silent, sturdy, portable, requires low maintenance and can be automatically controlled through a digital display that gives access to data and functions regulated by a circuit board (hardware) and a program (software), and it has a timer that generates a homogeneous mist of nutrient rich nanoparticles, composed by a basic mixture of water, organic mineral elements and other nutrients, which strengthens and enhances the growth of plants, making them healthier and tastier. The present invention introduces a unique system that promotes the oxygenation of the liquid solution and a constant renovation of oxygen in the chamber where the plant roots are suspended, and, in the absence of natural light, it can emulate light spectrums in wavelengths of about 420 nm to 730 nm, by installing a kit of three lights on the sealing cap of the device located at the upper part of the top growing module, where, as an option or alternative, a solar photovoltaic panel can be installed to guarantee its continuous operation.

The present invention comes ready for use, and includes stationary biochemical sensors to control water quality, as well as gauges, diluters, seeds, baskets, micro-greenhouse, etc. It can be used by non-skilled consumers, and anyone that doesn't have any knowledge or experience in plant cultivation. It can be used in all sorts of spaces like: apartments, balconies, houses, restaurants, schools, day-care centers, condos, supermarkets, offices, ranches, gardens, garage, basements, sheds, shops, mobile homes, boats and can even be used as a source of income for a family or for practice and capacitation in technical schools and agricultural labs. This device can be assembled as one unit, or it can be combined to other units to increase its capacity of production. One or more devices can also be sequentially interconnected, if desired, to increase productivity. It is suitable to be used under extreme conditions or in poor soil areas. The present invention allows plant cultivation and harvest almost all year-round. It can be programmed according to the characteristics of each plant, climate or preference of the user. It is suitable for cold or hot areas, on concrete floors, or in areas where the ground is dry, sandy or stony, without the need of special substrates. The focus is the use in the cities, thus enabling anyone to have a full flower or vegetable garden indoors. In addition to its main function, which is to produce vegetables, salad greens, and other organic food in the same way as would a regular garden, this system can be also used a decorative item or an ornamental garden that may be placed in any corner or space of a house, without the need to be supported on walls or the use of wires, ropes, hooks, chains, stakes, or covers. This invention is also an educational product as it could have experimental use in the field for research or even be referred as therapeutic (due to its capacity to improve reactions anti-stress, patience and the feeling of a more pleasant work routine or hobby). It is a differentiated product that instigate people's curiosity from the very first moment and offer a more sustainable way for a healthier life style that contributes for an overall sense of wellbeing and a happier life. It is an appealing system for plant cultivation of an array of flowers, cacti, mushrooms and aromatic herbs, and can hold tree seedling, for example. Another important benefit to mention is that this system prevents the spread of Aedes Aegypti, a mosquito that carries dengue and other diseases, as it is completely sealed. It offers the possibility of continuing education and learning as it is a product directly linked to plant life and physiology and time for harvest may vary according to region, climate, seed or sprouts quality, control of monitoring and analysis methods, and handling of species. The act of growing plants (living organisms), whose species and situations can change at any time according to location and time of planting, by simply adjusting the settings of this planting system for aeroponic plant cultivation create a gratifying feeling of vivacity, family integration, modern living, and for some, the satisfaction of having a gourmet garden at home. The present invention also brings a high social value that can eventually generate income upon family farms and be considered for use in programs that fight poverty. It is safe to assemble, the manufacturing material is sturdy, not bulky and it does not require any special tools for assembly. Its quick-closure fittings are easy and fast to connect. The technological concept of this invention is simple: Set up, plant and harvest: Simple like that.

The “standard” model is composed of 2 growing modules that have a planting capacity of 40 plants. A growing module is composed of a plurality of interspaced apertures, inclined individually at specific angles, with standardized dimensions and proportional distance that are proper for support, lighting and safe planting; The base of this invention constitutes of a triangular-shaped with rounded edges water reservoir, which was inspired by the Rouleaux's Triangle, and a conical shaped chamber, which is sealed and comprised into two parts: one part stores a nutrient rich solution that is kept inside of the system (the vase), the other part has an air pump for oxygenation and flow of the nutrient rich solution, which is equipped with an air hose and a micro noise reduction capsule, UV LED lights to prevent fungi and bacteria propagation, a floating buoy that holds a piezoelectric mini-generator of nanoparticles that works with a timer that is automatically triggered by the device's control system to create an aerodispersoid mist capable of spraying between 0.2251/h and 1.9751/h of nutrient rich nanoparticles directly into the suspended roots of the plants located inside of the dark chamber. The production of nanoparticles may vary according to the type of the mini-generator of the device which is determined according to the number of plants. The full system is formed by the junction of all modules, and there are sensors for monitoring the water located inside of the 2-part reservoir in the base of the module. On the top of the reservoir there is a lid used for water inspection and supply, an electronic box, a digital display with Wi-Fi communication, LED lights to indicated level index; waterproof micro-fans that are used for circulating air inside of the system, a built-in connection for a dual voltage power cable (electricity). The system has a double fastening and/or quick-closure fitting kit on the sides that attach all modules by pressure, or alternatively using magnets and electrical contact; a top sealing lid (with or without a solar panel) or 3 LED bulbs luminaires, which are adjustable and proper for growing and developing plants.

Note that 90% of this plant cultivating system is built with UV protected plastic and rubberized coverings, 8% of wires, connections and electrical components and 2% of metal parts, which are shielded to resist corrosion, moisture, oxidation and electric shock.

It is part of this method of planting supply products that are commercially available suck as digital tools to check levels of pH (potential of Hydrogen), TDS (Total Dissolved Solids) and/or EC (Electroconductivity), easy hookup rotation wheels; large plants support grid; pH balance kits; stabilizers; buffer solutions; balanced formula of liquid biochemical nutrients (organic, synthetic or mineral); starter planting kit with seeds; plastic tags with labels for identification (personalized chain or string tags placed next to plant growing cups to identify each plant); mini-greenhouses for the plant growing cups; rooting baskets; tubes, plant guiding rods made by bamboo or rubberized wires; seed capsules in foam cubes: phenolic compounds, rock wool, biodegradable polyurethane and special sponges soaked with antifungals, foliar agents and macro and micronutrients, whose open cells stimulates air circulation in the roots to promote seed germination directly into the capsules and, finally, supporting disks in all sizes, applications, dimensions and specifications standardized for cultivation in this type of system. The support disks are the actual disks that hold the plants in the air in aeroponics and they fit into the plant growing cups or into the empty rooting baskets, securing the seed germination sponges, seed pods and seed capsules into place.

All these accessories have been developed and adapted especially and for exclusive use on this invention. From the complementary items mentioned above, it is important to highlight: the support disks, which can be manufactured in several colors, with the shape and diameter of the plant growing cups customized according to the size of the desired plant, without compromising its use, and it is available in 4 types: I) Sealing cups—used to seal any unused plant growing cups; II) Bonding cups with a cut in form of a cross—used for seedlings and plant cutting; Ill) Germinating cups—used for planting seed capsules, foam cubes, phenolic compounds, rock wood, and all other means of planting, like the ones more traditionally and widely used in hydroponics; IV) Special sponge cups—used for germination and cultivation of small plants. The support disks models I, II and III are made with materials that are soft, rubber-covered, non-toxic, washable and temperature resistant. Model IV is made of a polyurethane foam and maintains the same dimensions of the rubberized models. The plant guiding rod may be inserted into any of the rubberized support disk to hold the stem of medium size plants, whenever necessary. For larger plants and vines, a semicircular grid is placed under the plant growing cup to support branches and fruits.

The irrigation method generated by the mini-generator creates the same effect as a morning dew, but only on the roots suspended in the air inside the plant growing cups, keeping under control temperature and humidity levels under control. This process prevents plant stress and promotes a better utilization of the solution, increasing productivity, and producing stronger and nutrient richer plants. Depending on location and weather, it is possible to control the program via smartphone, to increase or decrease irrigation time, receive alerts about water level and nutrients quality, with only few manual actions, naturally, quickly and easily. The process of interleaved irrigation, along with other essential factors of controlled lighting and oxygenation, causes the plant to develop microcapillaries in their roots and to adapt the system for maximum performance.

When the system is operating, the user is able, through a software, to visualize periodic reports, climate information, access a dictionary of technical terms, a library with tips concerning types of plants, best time for planting, etc., and answer a quiz of questions and answers. It is also possible to share experiences, pictures and videos and interact with other users by accessing the application, web platform or online forums.

It is possible to save up to 50% of nutrients if compared with the hydroponic and/or traditional aeroponic methods, since the instructions normally provided by the fertilizer's manufacturers do not have data about irrigation with nutrient rich nanoparticles, which, due to the size of the particles that are generated, by this invention, along with ideal conditions of oxygenation and lighting, are much easier for absorption, granting better plant quality and more retention of macro and micro nutrients. Thus, our instructions follow current and developing research available, and we offer a line of biochemical products and seed capsules more suitable for the aeroponic cultivation applied in this electronic vase.

To know when to add water and nutrients, just check the level indicator LED lights and, using a proper container, add water directly into the reservoir by removing the inspection and supply lid. The reservoir holds between 15 L and 90 L of the organic or mineral nutritional rich solution, but the intake will depend on the settings. The autonomy of self-irrigation may last more 30 days.

It is advisable to weekly monitor the pH, EC and TDS levels of the nutrient rich solution, by using the tools supplied with the product or by checking the built-in sensors to obtain better production results.

For planting from the germination stage, the user has to add water and nutrients to the reservoir, select the desired plant species, insert the seed capsules to the foam cube inside of the support disk, and place the disk into any of the plant growing cups or, according to preference, into the rooting basket, turn on the automated system, plug in into an outlet or other appropriate power source, and, after the recommended time, harvest the plants.

Harvesting is done the end of the cultivation process when plants may be consumed according to the need, avoiding waste, pruned plants can be kept in the system for regrowth or new plants can be planted using the available plant growing cups. So, there is always plants ready to harvest and in different stages of growth, in a revolving cycle.

For a better understanding, we describe and illustrate in the following figures all items that are part of this automated electronic vase for plant growing of and at the end we present a description with the possible alternatives of the system. Observe:

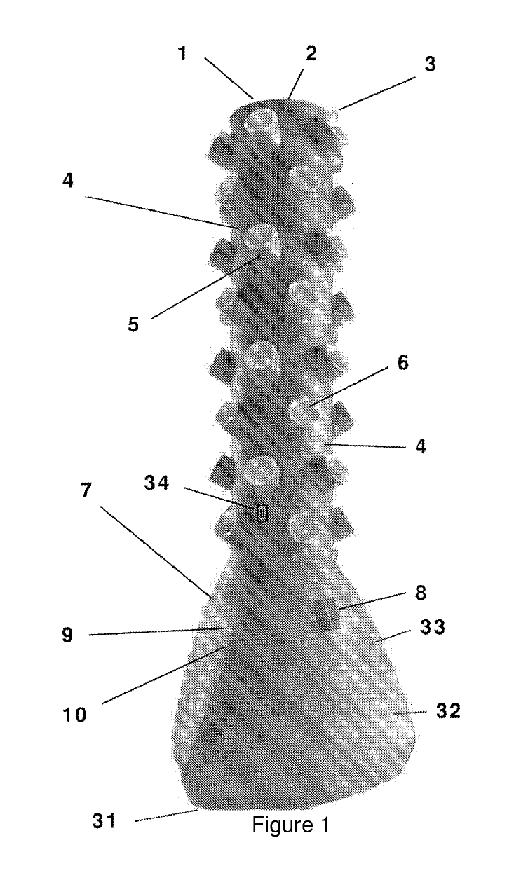

FIG. 1: Overview

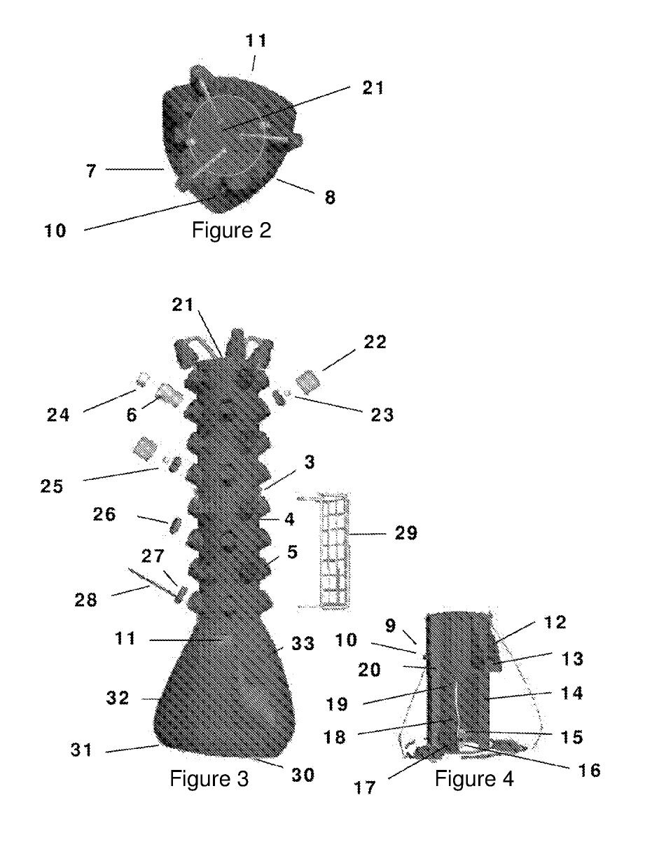

FIG. 2: Top View

FIG. 3: Front view with placement of accessories

FIG. 4: Inside view of the reservoir and its components

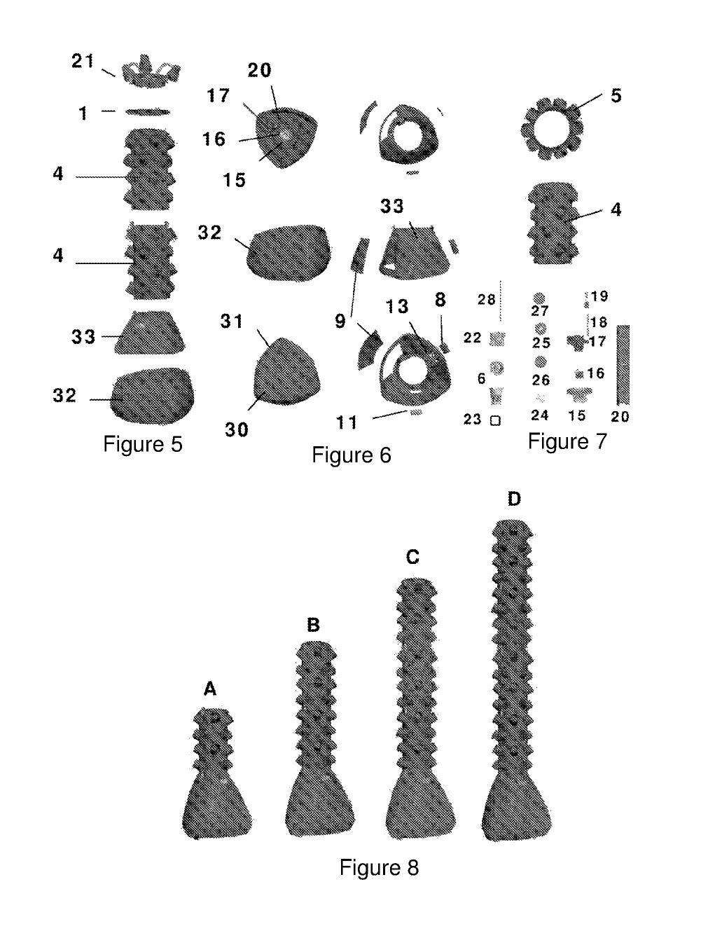

FIG. 5: View of the main sequence for assemble

FIG. 6: Detailed view of the reservoir (upper and lower)

FIG. 7: Detailed view of the module and other accessories

FIG. 8: Detailed view of the support disks, plant guiding rod and seed capsule

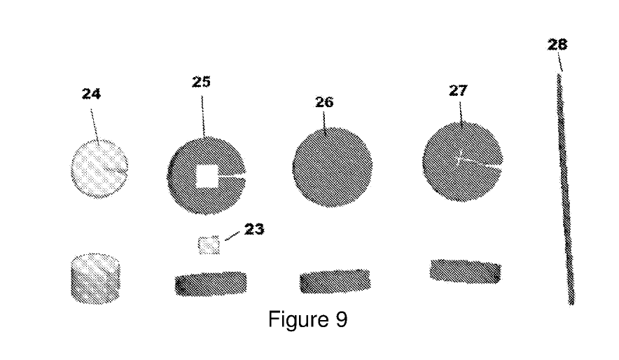

FIG. 9: Illustration with modules of 20, 40, 60 and 80 plants.

On the overview as illustrated on FIG. 1, we identify the location of the sealing cap (1) installed on the top, to close the top section the growing module (4). Each growing module is approximately 25 cm tall and includes a sturdy junction ring (2) attached to the upper part, 20 plant growing cups (5), installed right against the 73 cm cylindrical body of the growing module, at an inclination of about 33° which is the ideal angle for balancing, fitting, supporting, spacing and development of plants and for the capture of light (natural or artificial). Plant growing cups (5) are connected in the growing module (4) and symmetrically allocated across the growing module's full length in four (4) fivefold structures alternated by the central axis at angles of approximately 36°. Everything is made from high-quality, UV-stabilized, tinted, antifungal plastic. Growing modules can be interconnected to other growing modules (4) and to the base by using securing mounting clips (3) with double snap closure, made of stainless steel or equivalent, bolted to the sides by the upper part (female) and lower part (male) in an appropriate and reinforced area of the growing modules (4). Several accessories and other components may be added to the plant growing cups (5). FIG. 1 shows a customizable plastic tag attached to a bead chain or cord and identification tags (34) (tag) that displays planting date, plant species, and prediction in days of 1st harvest. The plant growing cups is sized to a perfect fit of the rooting basket (6), which is made of malleable and non-toxic plastic for carrying the roots of the plants and a support disk (24), (25), (26) and (27), shown in FIG. 3, FIG. 7 and FIG. 8. The support disk is responsible for supporting and holding the roots of the plants in the air. They come in three (3) main versions that are made of a flexible, rubberized, resistant, non-toxic, washable and temperature resistant material and one extra version (24), made of a spongy material previously prepared for seed germination and planting plants. Support disks (24), (25), (26) and (27) may be used in conjunction with the rooting basket (6) or directly in the plant growing cups (5), which is determined based on the type of plants to be grown and preference of the user. The rubberized support disks (25) and (27) can be used in conjunction with the plant guiding rod (28) which main function is to guide and sustain stems and, if used with seed capsule in phenolic sponges or equivalent (23), for sowing and germination of plants. Other accessories of the planting growing cups (5)—FIG. 1 include a micro-greenhouse (22)—FIG. 3 and FIG. 7 made from a malleable and clear plastic, meant for use only in the first days of germination of some plants or for protection of small seedlings.

FIG. 1 further shows the lid for water inspection and supply at the top of the water reservoir located at the base of this invention (33)—FIG. 5 (7) made from hard plastic that can be removed for adding water or the nutrient solution which stay in the bottom of the reservoir (32)—FIG. 5 and/or for allowing maintenance, quality control of the nutrient solution, periodically, by manually using the appropriate measuring instruments or sensors like pH and EC/TDS meters. This overview also shows the ventilation system protective grid (8) that leads the air into the internal duct (12) directed by a micro-fan (13), which is situated diagonally at the end of the inner duct (12), shown in detail in FIG. 6. The micro-fan (13) has an adequate CFM air flow is water-proof and used for air circulation and air exchange, cooling and maximization of oxygen in the roots of the plants. This set composes the ventilation system which is also responsible for the expansion and conduction of the nutrient rich nanoparticles mist, which along with the aperture at the inner platform (14)—FIG. 4 and the growing modules (4) form the dark chamber where occurs the irrigation of the roots of the plants that are accommodated in the growing modules (4) and suspended by one of the support disks (24), (25), (26)) and (27).

Next, the power switch (9) activates or interrupts the operation of the system and its electrical parts. Just below it is the connector of the power input (10) to the power cable (electric power) in conjunction with a dual control transformer, along with a plug and a standard triple pin plug (3-pin), included, in the system.

FIG. 2 shows the position of the 3 (three) main sides and the main access and control items of the reservoir (32) and (33) viewed from above, highlighting the protective grid (8) of the air inlet of the ventilation system; the connection of the power input (10); the lid for water inspection and supply (7) and the electronic panel display (11). Note the light triangular twist and rounded edges of the base of the inverted triangular conical vase, its refined design and polished finish. The extended cylindrical section designed for cultivation (dark air chamber) is composed by the conjunction of the growing modules (4), with an all-around distribution of the plant growing cups (5) that overlap each other, and a sealing cap that can hold a three-way lighting system (21). The lighting system consists of 3 (three) flexible and moveable luminaires, protective cones and LED luminaires used for the development of plants, arranged to cover all sides of the reservoir. This item (21) is recommended for areas without the incidence of natural light, as it creates the same effect of sunlight, however, in an artificial way, and all the recommendations of the lamp manufacturer must be followed. Note the details of the lighting kit in FIG. 2, FIG. 3 and FIG. 5.

The sealing cap (1) can be optionally substituted by a sealing cap with lights (21), or vice versa. Electric and connecting cables located in the inner part are waterproof and dustproof to avoid the risk of electrical shocks when in contact with water. Nevertheless, the whole system works with a low voltage of maximum 12 v-24 v, so it is harmless to humans (adults and children) and domestic animals. The entire device is protected, and the electric power conversion occurs via the power cable transformer (with a minimum length of 2.0 m), which is installed next to the outlet in a safe area, in accordance with ABNT standards. It is recommended that the power switch (9) is turned to the OFF position when handling the device and, if possible and to guarantee total safety, with the power cable disconnected from the outlet or power source. Notes and instructions for use and safety are attached to the device.

Further items of this invention are: the semi-circular shaped support tray (29) made of a plastic covered structure, which main function is to support larger plants, shrubs, fruits, vegetables or vines or tomatoes. The semi-circular shaped support tray (29) is optional and may be placed or removed according the preference of the user. It is placed on the plant growing cups (5) or junction ring (2) and positioned between the growing modules (4), staying on the side of the system as shown in FIG. 3; At the bottom of this invention, there are three (3) rotating wheels (30) shown in FIG. 3 and FIG. 6, which are optional and can be quickly attached or removed from the nutrient reservoir base (32). By removing all 3 (three) rotating wheels (30), the sustention of this invention is converted to the supporting feet (31) that are distributed at the border of the nutrient reservoir base (32) for more stability of the entire device.

Situated in the middle of the reservoir top lid (33), and just below the primary growing module (4) is the electronic panel display with a digital menu (11) shown in FIG. 3 with Wi-Fi communication, colored LED lights that indicate the level of water and/or the nutrient rich solution; the room temperature; the relative air humidity (internal); controls the timer to change irrigation times and intermission according to desired guidelines or based on the sensors ‘readings, local climate and the automatic triggering functions of the components displayed internally in FIG. 4, which finish the composition of the “standard” model system: the floating buoy with basket (15) that stores the mini-generator (16) which is capable of generating between 0.225 l/h and 1.975 l/h of the nutrient rich nanoparticles mist that is directly sprayed to the roots of plants. This prevents the solution from damaging the roots, keeping the temperature and humidity automatically controlled between 10° C. and 35° C. Other settings can be applied according to the user's need. Add to the project the aeration pump (17), that causes the oxygenation and provides circulation of the nutrient solution, mounted to the air hose (18), made from silicone or malleable plastic, inserted into the noise reduction capsule (19) that comes with a small hole in the upper part for air suction to ensure an operation free of vibrations and noises throughout the internal system which is immersed, secured and sealed inside the reservoir (32) and (33), disposed within in FIG. 4. The measurer of level sensors (20) is mounted on a flat, solid and thin plastic base with a sliding fit on the inner platform (14) where rustproof level sensors are attached to the colored LED lights in red (lower level), yellow (normal level), green (higher level) that are inserted into the electronic panel display (11) that sends, via Wi-Fi signals, alerts about activity and reports about controls and monitoring directly to the web, making it necessary to have available internet connection and compatibility between devices.

The cultivation system of this electronic device for plant cultivation can be coupled to other growing modules (4) thus increasing its vertical capacity of production without the need of the base expansion. You can add more growing modules (4) as needed, being the suggested amount one at minimum and 4 at maximum, plus the 2-part reservoir (32) and (33)—FIG. 9, as shown in FIG. 8. Each model is classified by the maximum growing capacity of plant growing cups, therefore model (A) supports 20 plants, model (B), considered the “standard” and used to illustrate this project, supports 40 plants, model (C) supports 60 plants and model (D) supports 80 plants. Note, as a remark, that models (A) and (B) use the type 1 low power mini-generator (15) and models (C) and (D) use the type 3 high power mini-generator of nanoparticles, and these models do not need rotating wheels (30) nor the sealing cap with lights (21) to maintain its structural stability and keep its high quality, ergonomics and safety.

The present invention is totally customizable and adaptable to most conditions of use and situations. The growing modules (4), plant growing cups (5) and junction rings (2) mentioned before, are assembled or constructed together in a single unit, and the water reservoir in the shape of a triangle with a twisted base is composed of a top lid (33) and the nutrient base (32) that are connected by quick-closure fittings, and have specific shape, size, technical details and interconnection between components and accessories that are unique of this invention its detailed description.

However, note that attempts to make alternative options by third parties are notorious, comprehensible and susceptible, in the following aspects: To change the shape of the reservoir that is connected by parts (32) and (33), to round, square, trapezoid, elongated, conical, star-shaped, domed, hexagonal, rectangular, so as well as in other shapes, as long as it is sealed at the top with an aperture to fit the growing modules (4) keeping its functions and integration to which may vary in sizing, the external cylindrical body, the number, layout and arrangement of the plant growing cups (5) which are elongated, located externally and integrated into the growing module at angles between 20° and 45°, being 33° the ideal inclination, and containing, as a key part, an electronic digital panel with Wi-Fi connection and having all systems and sensors included and with same functionality of the electric device in accordance with this invention without changing the functionality, operation, applications, usage instructions, performance or the founding principles of the invention to which utilizes the generation and distribution of a nutritional nanoparticle mist inside the dark chamber for aeroponics cultivation formed by the junction of growing modules, whether it is connected by clamps, clasps, pressure clips, snap, fittings, bolted etc. or to enhance the manufacturing technique the by this patent applicant, by his heirs or any people/companies authorized in writing, duly legalized and properly documented in the competent agencies established to the inventor.

To illustrate examples of the design alternatives therein, simply reposition and maintain the same components—the growing modules, reservoir and accessories, represented as a typical vase, however, it is possible to change the shape of the nutrient solution reservoir, by replacing the nutrient reservoir (32), by cachepots or other known waterproof vases or containers commercially available that may be used to store the nutrient solution, which may vary in color, shape, make, model and capacity in liters, according to preference. This new alternative must have been previously sealed at the bottom, closed with a lid and with a hole near the top edge, above the water level, used as a cable outlet for all cables and connections of the control and monitoring systems, and may not exceed the height limit stipulated by the seamless inner platform base, keeping design and dimensions as close as possible to the original project, regardless of proportion. The electronic panel with digital display (11) equipped with timer, Wi-Fi, fans, sensors and level lights which are positioned between the plant growing cups or the growing modules should be kept at the base of the module or bottom of the reservoir. The extended cylindrical sections (dark air chamber) formed by the conjunction of the growing modules (4) is inserted into the mid part of the plastic cachepot (vase) part of any sealed waterproof container and supported against its partially submerged inner platform.

For closure, in substitution of the reservoir top lid (33) an lid located on the upper part, cut in the same shape as the upper aperture of each type of container may be used. Any rigid or rubberized material of proper thickness may be used for sealing. This lid may contain an attached micro-fan (13) and an inspection and supply lid slightly positioned horizontally.

These alternatives of the “simplified” model should be used directly on the floor, and the use of supports with rotating wheels or equivalent for stability and structural balance is not necessary as it become more stable when the water level is full.

All other components and accessories functions remain unchanged, in particular, those applied directly to the plant growing cups (5) and to the ones used internally within the reservoir, previously mentioned.

To conclude the solution presented by the present invention it is important to highlight the functionality, versatility, design, electronics and set of technical specifications for use in aeroponic plant cultivation, along with unique functionalities that integrate in a single device numerous solutions mainly for urban agriculture, that enables people to plant in a way that is simpler, safer and more economical, dynamic, comfortable, technological, modern and intelligent, of a system referred as: “Modular electronic vase with automated control, digital control and monitoring system, used for aeroponic growth of plants in inner and outer environments”, inspired by the advanced techniques of hydroponics and aeroponics destined for urban cultivation and, in case additional questions, the inventor is available for any subsequent clarification or information which may arise.

1. “MODULAR ELECTRONIC VASE WITH AUTOMATED, DIGITAL CONTROL AND MONITORING SYSTEM, USED FOR AEROPONIC GROWTH OF PLANTS IN INNER AND OUTER ENVIRONMENTS” wherein the top external portion has a sealing cap (1) and/or cap (21), which includes a lightning kit with three luminaires proper for plant growth, stackable growing modules (4), junction rings (2), a plurality of plant growing cups (5), symmetrically positioned at an angle where several accessories are attached such as rooting basket (6), micro-greenhouse (22), foam cube seed capsule for germination (23), support disks (24), (25), (26) and (27), plant guiding rod (28), support tray (29) and identification tags (34), completed by a water reservoir divided in two parts (32) and (33). The water inspection and supply lid (7), protective grid (8), on/off power switch (9), power input (10) for the power cable, rotating wheels (30), supporting legs (31), and, in particular, electronic panel with digital display (11) that displays information about the level of the nutrient solution, temperature, humidity, timer control and automatic actuation functions of the components as presented in FIG. 4, where power cables of all electric components and electronic circuits are protected and housed inside, are in this portion, along with the floating buoy (15) that holds the mini-generator (16) of the nutrient rich solution nanoparticles, aeration pump (17) with air hose (18) and a noise reduction capsule (19), a sensor level ruler (20). The aero cultivation system of this electronic device can be coupled to other growing modules (4) thus increasing its vertical capacity of production without the need of the base expansion, as presented in FIG. 8. The invention is customizable, adjustable and comes in different colors. The growing modules (4) with plant growing cups (5) and junction ring (2), mentioned above, are welded or constructed in one piece and coupled to the two-part reservoir, affixed by fast fitting securing mounting clips (3). The design has specific shape, size, technical details with interconnection between components and accessories that are unique of this invention, as mentioned in the specification. The apparatus is programmable, with wi-fi communication to send alerts and reports via application or web platform to smartphone or similar. It comes ready for use, further including: pH, TDS/EC sensors, and standard fittings to be used with the specific software (firmware) and hardware (circuitry) assemble of this urban cultivation of plants system.
